(19) United States
(12) Patent Application Publication
(10) Pub. No.: US 2010/0174648 A1
(43) Pub. Date: Jul. 8, 2010

(54) SECURE REAL-TIME BUSINESS PROCESSING SYSTEMS

(75) Inventors: Daniel W. Krantz, Flemington, NJ (US); Shawn Wood, Stewartsville, NJ (US); Tim Surface, Raleigh, NC (US); Gerri Papillon, East Stroudsburg, PA (US); Brian Roberds, Broken Arrow, OK (US)

Correspondence Address: Daniel W. Krantz;IndustrySuite LLC, Suite 305, 1 State Route 12, Flemington, NJ, 08822, US

(73) Assignee: IndustrySuite, LLC, Flemington, NJ (US)

(21) Appl. No.: 12/254,952

(22) Filed: Oct. 21, 2008

Related U.S. Application Data
(60) Provisional application No. 61/000,718, filed on Oct. 29, 2007.

(51) Int. Cl. G06N 5/02; G06Q 20/00; G06Q 10/00; G06Q 99/00

(52) U.S. Cl. 705/44; 705/301; 705/325; 706/47; 706/50

(57) ABSTRACT

The present disclosure provides a dynamic business system comprising a business intelligence processing module; a dynamic rules module coupled to said business intelligence module; a dynamic collaboration engine coupled to said dynamic rules module and said business intelligence processing module; a data mining and expert knowledge module coupled to said interoperable system wherein said expert knowledge module can effect a portion of a data set to undergo real-time modification. The system data output and reporting is provided via a secure online method providing real-time interoperability among disconnected facilities. Additionally, the dynamic business system described provides dynamic and real-time decision making capabilities based on third party's available data set wherein data output and reporting is provided via a secure online method providing real-time interoperability among disconnected facilities.

### FIELD OF THE INVENTION

The present disclosure relates generally to business information systems and in particular to achieving secure real-time information access, rules management and verification strategies.

### BACKGROUND OF THE INVENTION

Modern business software including the utilization of expert systems is designed to support critical business operations. These systems are designed to manage schedules, provide worker credentials and verification, and improve many other products and services and the like. A diagram of an expert system according to conventional art is depicted in FIG. 1. The expert system of FIG. 1 comprises a knowledge module and a rules engine. The rules engine of this system applies information as contained in the knowledge module according to a set of rules. Widely used current systems are static. While these systems allow a user to modify the organization of knowledge, the system cannot allow the collection of operating parameters during the execution step. When the system does collect operating parameter information, the user is unable to modify the organization of the knowledge. Facile and intuitive real-time decision making is also not available with these systems. Many of today's enterprise systems are inefficient due to impeded flow of information between entities, static data storage, complex interfaces or a combination thereof. Thus, there is a continuing need for improved, user-friendly, processes that operate in real time and with adequate granularity to facilitate today's business processes.

### SUMMARY OF THE INVENTION

Embodiments of the disclosed systems provide a dynamic expert system comprising a module-driven suite of technologies that provide a centralized data clearinghouse in tandem with a credentials management system and applications thereof.

One embodiment of the present disclosure is a real-time interoperable system comprising a business intelligence processing module; a dynamic rules module coupled to said business intelligence module; a dynamic collaboration engine coupled to said dynamic rules module and said business intelligence processing module; a data mining and expert knowledge module coupled to said interoperable system wherein said expert knowledge module can effect a portion of a data set to undergo real-time modification; wherein system data output and reporting is provided via a secure online method providing real-time interoperability among disconnected facilities.

Another embodiment of the present disclosure is a real-time interoperable system comprising a business intelligence processing module; a dynamic rules module coupled to said business intelligence module; a dynamic collaboration engine coupled to said dynamic rules module and said business intelligence processing module; a data mining and expert knowledge module coupled to said interoperable system wherein said expert knowledge module can effect a portion of a data set to undergo real-time modification; wherein data output and reporting is provided via a secure online method providing real-time interoperability among disconnected facilities.

Still another embodiment of the present disclosure is a real-time interoperable system comprising a business intelligence processing module; a dynamic rules module coupled to said business intelligence module; a dynamic collaboration engine coupled to said dynamic rules module and said business intelligence processing module; a data mining and expert knowledge module coupled to said interoperable system wherein said expert knowledge module can effect a portion of a data set to undergo real-time modification; wherein third party's business processes are emulated

These and additional features and attributes of the disclosed embodiments or systems of the present disclosure and their advantageous uses and/or applications will be apparent from the detailed description that follows.

### BRIEF DESCRIPTION OF THE DRAWINGS

For those of ordinary skill in the relevant art in using the subject matter described herein, reference is made to the appended figures that are examples of embodiments in which:

FIG. 1 shows a block diagram of an expert system according to the conventional art.

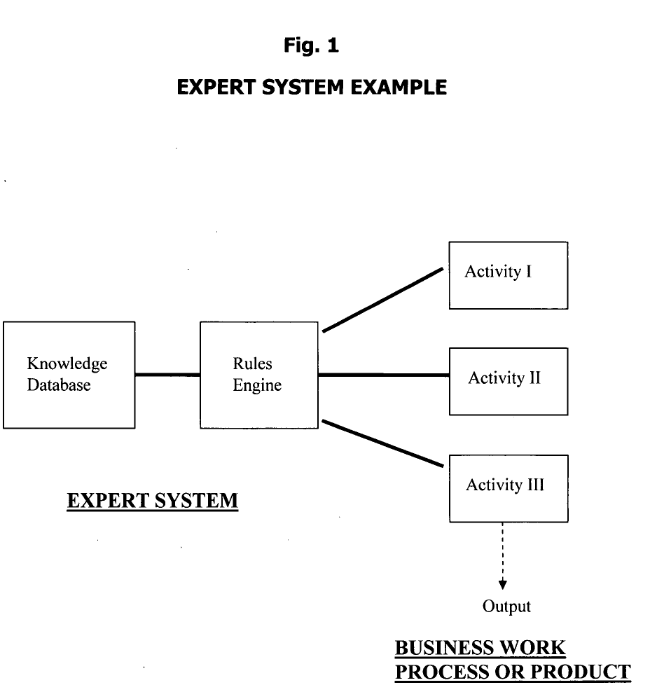

FIG. 2 shows a flow diagram of an exemplary interoperable method of dynamically acquiring data and employing a process.

FIG. 3 shows a flow diagram of an exemplary method of incorporating an interoperable data mining and expert knowledge process in the expert system in accordance with one embodiment of the present disclosure.

FIG. 4 shows a flow diagram of an exemplary interoperable card printing system in accordance with one embodiment of the present disclosure.

FIG. 5 shows a block diagram of an exemplary interoperable system for implementing embodiments of the present disclosure with remote hand held wireless devices.

FIG. 6 shows a block diagram of an exemplary interoperable system for implementing embodiments of the present disclosure with access control devices.

FIG. 7 shows a flow diagram of an exemplary method for implementing interoperable certification management processes as an exemplary embodiment of the present disclosure.

FIG. 8 shows a flow diagram of an exemplary method for implementing interoperable certification equivalency as a management process as an exemplary embodiment of the present disclosure.

FIG. 9 shows a flow diagram of an exemplary method for implementing interoperable notification using the interoperability of the exemplary system.

### DETAILED DESCRIPTION OF THE PREFERRED EMBODIMENTS

The subject matter described herein will now be referenced in detail, examples of which are illustrated in the accompanying drawings. This disclosure describes a module system including a method of managing data that is permission based and rules operated. Additionally, the module system operates in real time. The present disclosure provides a dynamic business system comprising a business intelligence processing module; a dynamic rules module coupled to said business intelligence module; a dynamic collaboration engine coupled to said dynamic rules module and said business intelligence processing module; a data mining and expert knowledge module coupled to said interoperable system wherein said expert knowledge module can effect a portion of a data set to undergo real-time modification. The system data output and reporting is provided via a secure online method providing real-time interoperability among disconnected facilities. Additionally, the dynamic business system described provides dynamic and real-time decision making capabilities based on third party's available data set wherein data output and reporting is provided via a secure online method providing real-time interoperability among disconnected facilities.

The accompanying examples illustrate the present disclosure and the advantages thereto without limiting the scope thereof.

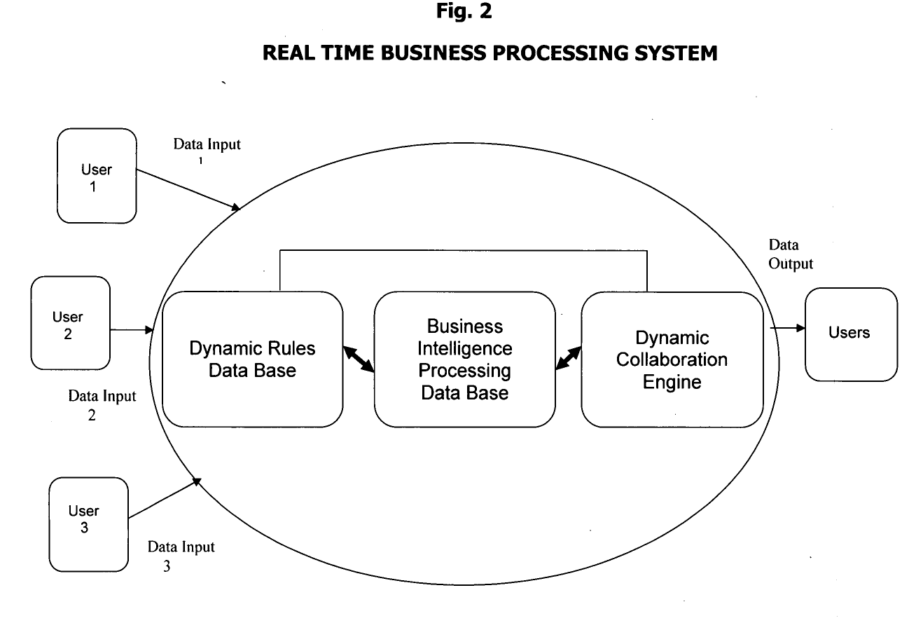

Referring now to FIG. 2, a flow diagram of an exemplary interoperable method of dynamically acquiring data and employing a process in accordance with an embodiment of the processes disclosed herein is shown. As shown in FIG. 2, the method comprises a dynamic rules module built from one or more available data structures in a business intelligence module and a dynamic collaboration engine. The dynamic rules module comprises one or more data structures wherein each data structure is populated with a plurality of corresponding rules. As data is added to the business processing system of FIG. 2, the dynamic rules module is modified in real time and a specific data structure or data structures applicable to a particular project, process or the like and the needed corresponding rules are copied to a subset module, a project or process module. Based on the dynamic rules protocols, various users will thus obtain differing subset modules in a secure manner. These users may individually manipulate the data structure provided for individual requirements. The user may provide additional and/or modified data to the expert system that in real time modifies the dynamics rules module in an interoperable real time dynamic feedback loop system. Users may provide additional information in various forms including, but not limited to, white papers, sales data, pricing data, technical publications, trade journals, personnel information, etc.

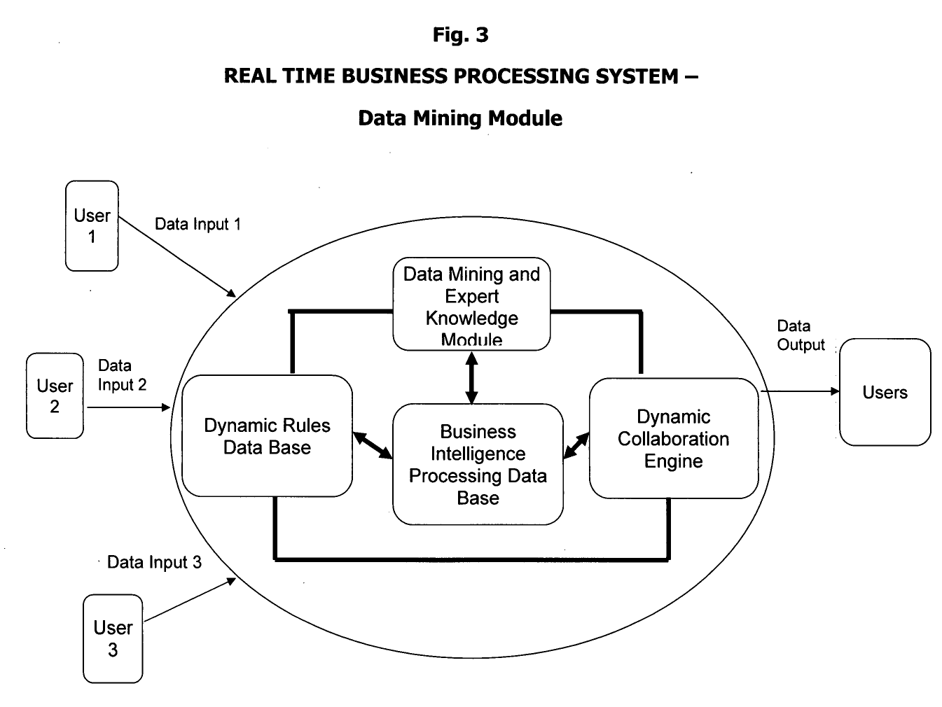

Referring now to FIG. 3, a flow diagram of an expert system in accordance with one embodiment of the present disclosure is shown. As shown in FIG. 3 the expert system comprises a business intelligence processing module, a dynamic rules module, a dynamic collaboration engine and a data mining and expert knowledge module. The interoperable system is one in which the business intelligence processing module is coupled to the dynamic rules module and to the dynamic collaboration engine. The dynamic rules module and the dynamic collaboration engine are communicatively coupled to each other and to the data mining and expert knowledge module. The dynamic rules module comprises one or more data structures wherein each data structure is populated with a plurality of corresponding rules. As data is added to the business processing system of FIG. 3, the dynamic rules module is modified in real time and a specific data structure or data structures applicable to a particular project, process or the like and the needed corresponding rules are copied to a subset module, a project or process module. Based on the dynamic rules protocols, various users will thus obtain differing subset modules in a secure manner. These users may individually manipulate the data structure provided for individual requirements. The user may provide additional and/or modified data to the expert system that in real time modifies the dynamics rules module in an interoperable real time dynamic feedback loop system. The data mining and expert knowledge module input effects real-time modification of a business intelligence processing module and/or a dynamic rules module. Users are restricted in their ability to modify the dynamic rules module based on the business intelligence processing module.

The embodiment described in FIG. 3 may provide each user with two data output sets. One is a data set tailored to the specific end user according to the dynamic rules module and the second is a shared data set among independent third-party users according to the dynamic rules module.

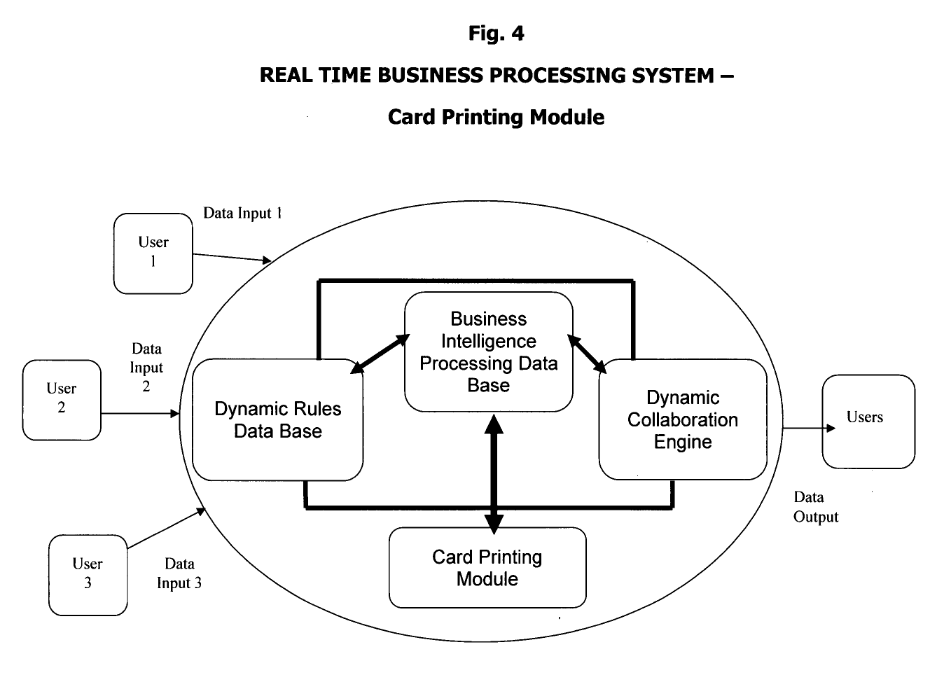

Referring now to FIG. 4, a flow diagram of an exemplary interoperable card printing system in accordance with one embodiment of the present disclosure is shown. As shown in FIG. 4 the expert system comprises a business intelligence processing module, a dynamic rules module, a dynamic collaboration engine and a card printing module. A data mining and expert mining module may optionally additionally be in the system. The interoperable system is one in which the business intelligence processing module is coupled to the dynamic rules module and to the dynamic collaboration engine. The dynamic rules module and the dynamic collaboration engine are communicatively coupled to each other, to the card printing module, and optionally to the data mining and expert knowledge module. The dynamic rules module comprises one or more data structures wherein each data structure is populated with a plurality of corresponding rules. As data is added to the business processing system of FIG. 4, the dynamic rules module is modified in real time and a specific data structure or data structures applicable to a particular project, process or the like and the needed corresponding rules are copied to a subset module, a project or process module. Based on the dynamic rules protocols, various users will thus obtain differing subset modules in a secure manner. These users may individually manipulate the data structure provided for individual requirements using the card printing module. The user may provide additional and/or modified data to the expert system that in real time modifies the dynamics rules module in an interoperable real time dynamic feedback loop system. Optionally, the data mining and expert knowledge module input effects real-time modification of a business intelligence processing module and/or a dynamic rules module. Users are restricted in their ability to modify the dynamic rules module based on the business intelligence processing module.

The embodiments described in FIG. 4 may provide each user with two data output sets. One is a data set tailored to the specific end user according to the dynamic rules module and the second is a shared data set among independent third-party users according to the dynamic rules module. Thus card printing as an exemplary embodiment can be generated according to the specific requirements of a single user. Optionally a set of unconnected entities can agree upon a common set of rules according to the dynamic rules module thus enabling the generation of card printing according to these common rules. The dynamic rules module can be modified in real time through the secure interoperability of the expert system of this embodiment.

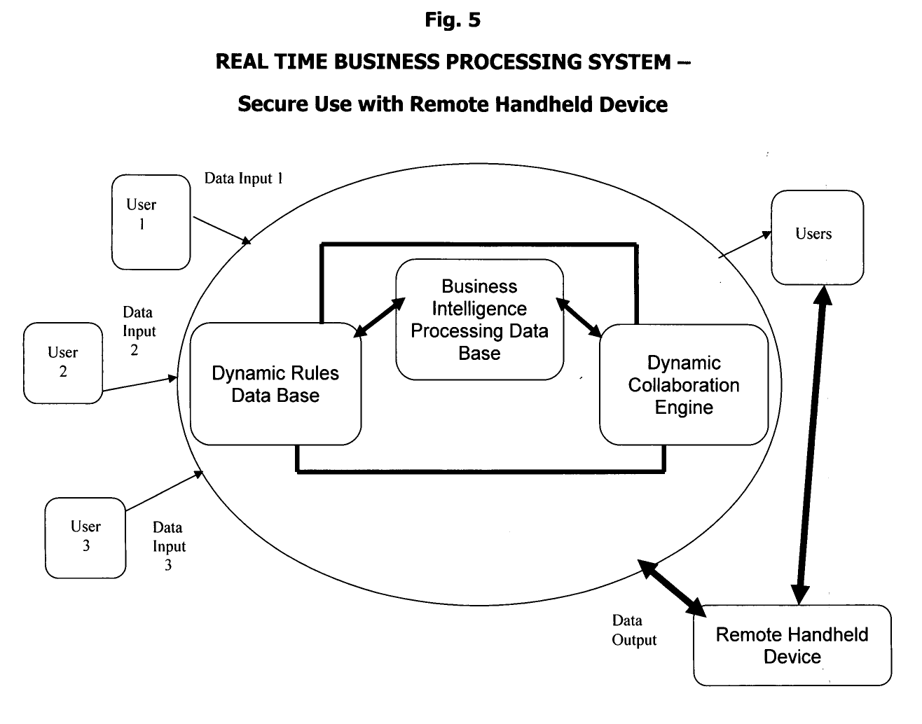

Now referring to FIG. 5, a block diagram of an exemplary interoperable system for implementing embodiments of the present disclosure with remote hand held wireless devices is shown. As shown in FIG. 5, the method comprises a dynamic rules module built from one or more available data structures in a business intelligence module and a dynamic collaboration engine. The dynamic rules module comprises one or more data structures wherein each data structure is populated with a plurality of corresponding rules. As data is added to the business processing system of FIG. 5, the dynamic rules module is modified in real time and a specific data structure or data structures applicable to a particular project, process or the like and the needed corresponding rules are copied to a subset module, a project or process module. Based on the dynamic rules protocols, various users will thus obtain differing subset modules in a secure manner. As shown in FIG. 5, one embodiment of this disclosure exemplifies the receipt of output data via a remote handheld wireless device. These users may individually manipulate the data structure provided for individual requirements. Optionally a set of unconnected entities can agree upon a common set of rules according to the dynamic rules module thus sharing a common set of data according to these common rules. The dynamic rules module can be modified in real time through the secure interoperability of the expert system of this embodiment. The user may provide additional and/or modified data to the expert system from the remote handheld wireless device that in real time modifies the dynamics rules module in an interoperable real time dynamic feedback loop system. Users may provide additional information in various forms including, but not limited to, white papers, sales data, pricing data, technical publications, trade journals, personnel information, etc.

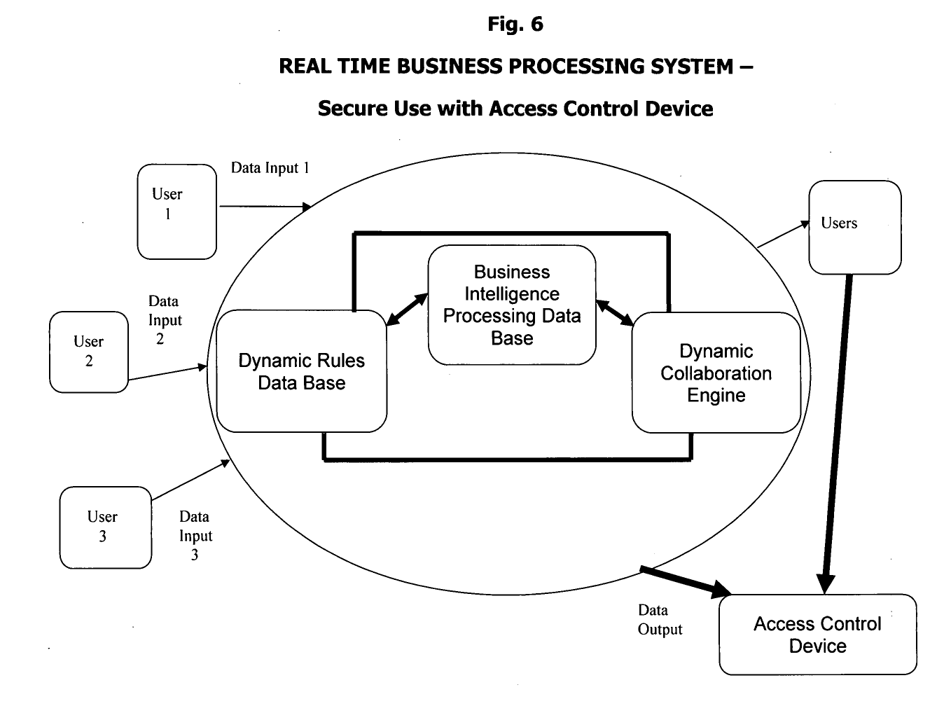

Referring to FIG. 6, a block diagram of an exemplary interoperable system for implementing embodiments of the present disclosure with access control devices is shown. As shown in FIG. 6, the method comprises a dynamic rules module built from one or more available data structures in a business intelligence module and a dynamic collaboration engine. The dynamic rules module comprises one or more data structures wherein each data structure is populated with a plurality of corresponding rules. As data is added to the business processing system of FIG. 6, the dynamic rules module is modified in real time and a specific data structure or data structures applicable to a particular project, process or the like and the needed corresponding rules are copied to a subset module, a project or process module. Based on the dynamic rules protocols, various users will thus obtain differing subset modules in a secure manner. Optionally a set of unconnected entities can agree upon a common set of rules according to the dynamic rules module thus enabling the sharing of a common set of data according to these common rules. The dynamic rules module can be modified in real time through the secure interoperability of the expert system of this embodiment. As shown in FIG. 6, one embodiment of this disclosure exemplifies the receipt of output data via an access control device. These users may individually manipulate the data structure provided for individual requirements. Users may provide additional information in various forms including, but not limited to, white papers, sales data, pricing data, technical publications, trade journals, personnel information, etc.

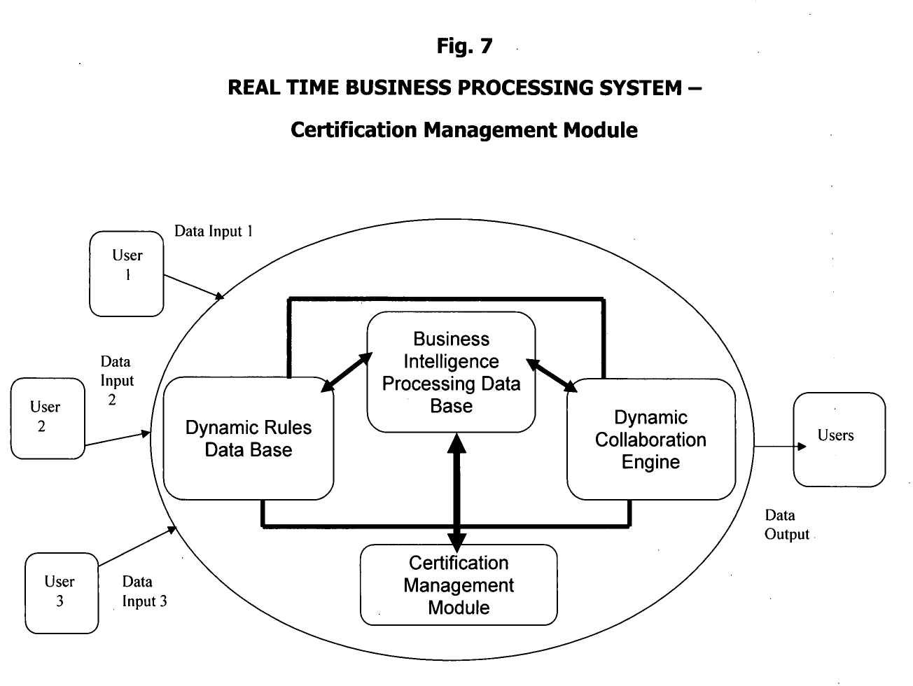

Referring now to FIG. 7, a flow diagram of an exemplary certification management module in accordance with one embodiment of the present disclosure is shown. An exemplary certification management module is one enabling the addition, removal, change and/or facilitation of certifications via an interoperable real time analysis of a data structure. Exemplary certifications are background checks, OSHA training modules, drug tests and the like, in fact any qualification that is required for personnel to have approval to work at a given site or sites.

As shown in FIG. 7 the expert system comprises a business intelligence processing module, a dynamic rules module, a dynamic collaboration engine and a certification management module. A data mining and expert mining module may optionally additionally be in the system. The interoperable system is one in which the business intelligence processing module is coupled to the dynamic rules module and to the dynamic collaboration engine. The dynamic rules module and the dynamic collaboration engine are communicatively coupled to each other, to the certification management module, and optionally to the data mining and expert knowledge module. The dynamic rules module comprises one or more data structures wherein each data structure is populated with a plurality of corresponding rules. As data is added to the business processing system of FIG. 7, the dynamic rules module is modified in real time and a specific data structure or data structures applicable to a particular project, process or the like and the needed corresponding rules are copied to a subset module, a project or process module. Based on the dynamic rules protocols, various users will thus obtain differing subset modules in a secure manner. These users may individually manipulate the data structure provided for individual requirements. The user may provide additional and/or modified data to the expert system that in real time modifies the dynamics rules module in an interoperable real time dynamic feedback loop system. Optionally, the data mining and expert knowledge module input effects real-time modification of a business intelligence processing module and/or a dynamic rules module. Users are restricted in their ability to modify the dynamic rules module based on the business intelligence processing module.

The embodiments described in FIG. 7 may provide each user with two data output sets. One is a data set tailored to the specific end user according to the dynamic rules module and the second is a shared data set among independent third-party users according to the dynamic rules module. Thus certification management as an exemplary embodiment can be generated according to the specific requirements of a single user. Optionally a set of unconnected entities can agree upon a common set of rules according to the dynamic rules module thus enabling the addition, removal, change and/or facilitation of certifications via an interoperable real time analysis of a data structure. The dynamic rules module can be modified in real time through the secure interoperability of the expert system of this embodiment.

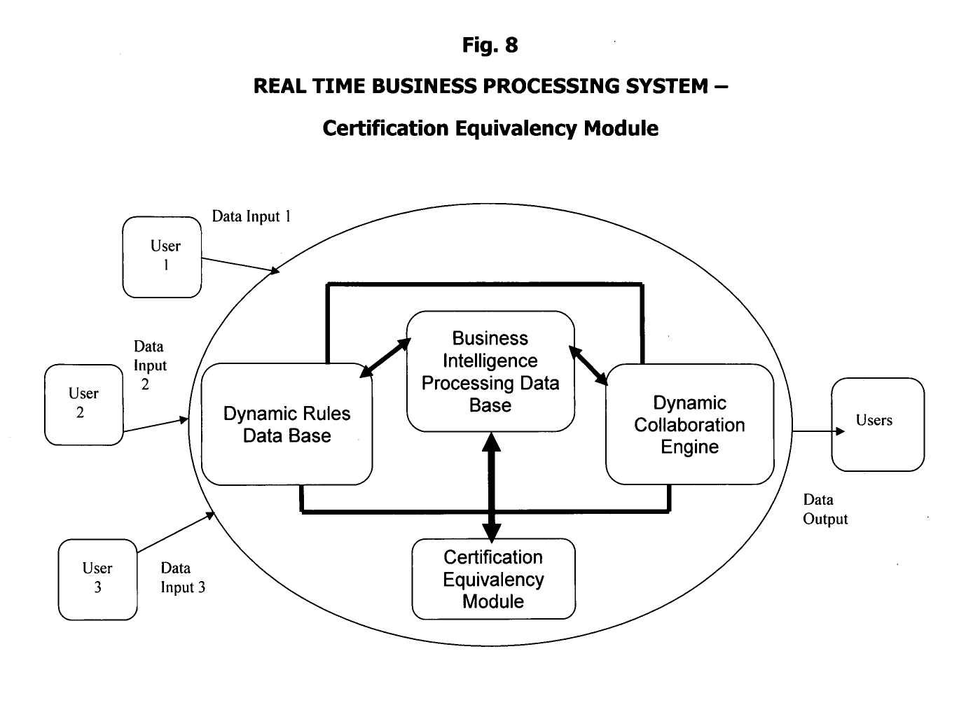

Referring now to FIG. 8, a flow diagram of an exemplary method for implementing interoperable certification equivalency as a management process as an exemplary embodiment of the present disclosure is shown. Certification Equivalencies or Substitutes is exemplified by Safety Training “A” being considered by all qualifying parties to be equivalent to or a substitute for Safety Training “B”.

As shown in FIG. 8 the expert system comprises a business intelligence processing module, a dynamic rules module, a dynamic collaboration engine and a certification management module. A data mining and expert mining module may optionally additionally be in the system. The interoperable system is one in which the business intelligence processing module is coupled to the dynamic rules module and to the dynamic collaboration engine. The dynamic rules module and the dynamic collaboration engine are communicatively coupled to each other, to the card printing module, and optionally to the data mining and expert knowledge module. The dynamic rules module comprises one or more data structures wherein each data structure is populated with a plurality of corresponding rules. As data is added to the business processing system of FIG. 8, the dynamic rules module is modified in real time and a specific data structure or data structures applicable to a particular project, process or the like and the needed corresponding rules are copied to a subset module, a project or process module. Based on the dynamic rules protocols, various users will thus obtain differing subset modules in a secure manner. These users may individually manipulate the data structure provided for individual requirements using the certification equivalency module. The user may provide additional and/or modified data to the expert system that in real time modifies the dynamics rules module in an interoperable real time dynamic feedback loop system. Optionally, the data mining and expert knowledge module input effects real-time modification of a business intelligence processing module and/or a dynamic rules module. Users are restricted in their ability to modify the dynamic rules module based on the business intelligence processing module.

The embodiments described in FIG. 8 may provide each user with two data output sets. One is a data set tailored to the specific end user according to the dynamic rules module and the second is a shared data set among independent third-party users according to the dynamic rules module. Thus certification equivalency as an exemplary embodiment can be generated according to the specific requirements of a single user. Optionally a set of unconnected entities can agree upon a common set of rules according to the dynamic rules module thus enabling the generation of certification equivalency module according to these common rules. The dynamic rules module can be modified in real time through the secure interoperability of the expert system of this embodiment.

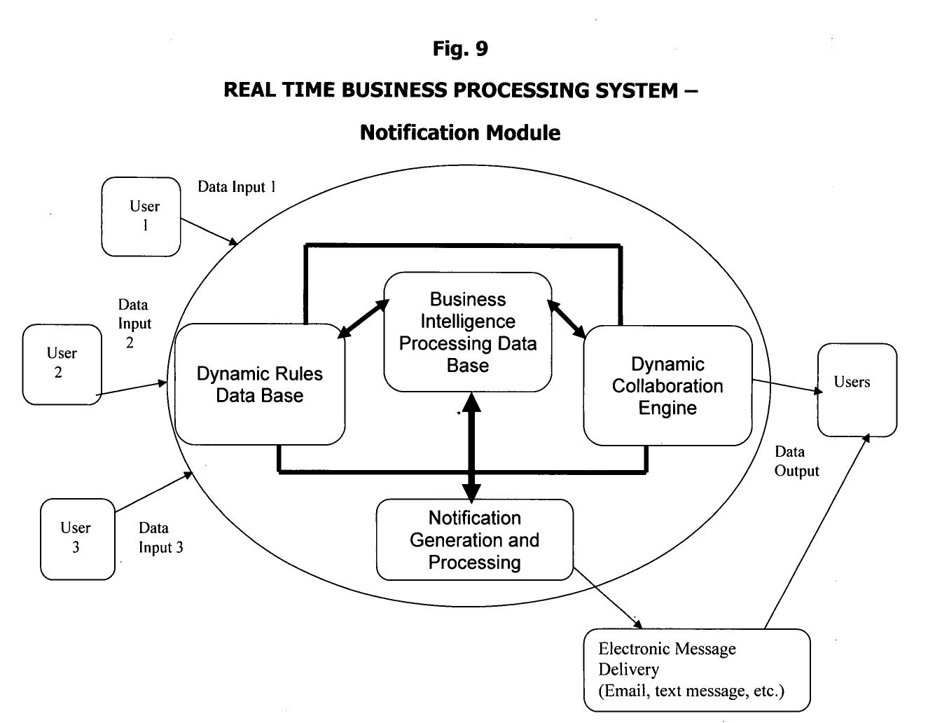

Referring now to FIG. 9, a flow diagram of an exemplary method for implementing interoperable notification using the interoperability of the exemplary system is shown. As shown in FIG. 9 the expert system comprises a business intelligence processing module, a dynamic rules module, a dynamic collaboration engine and a notification module. The notification module is exemplified by its ability to react both to the user and to dynamically defined “triggers” or “rules” to allow for the sending an electronic message(s) to specific user(s).

A data mining and expert mining module may optionally additionally be in the system. The interoperable system is one in which the business intelligence processing module is coupled to the dynamic rules module and to the dynamic collaboration engine. The dynamic rules module and the dynamic collaboration engine are communicatively coupled to each other, to the notification module, and optionally to the data mining and expert knowledge module. The dynamic rules module comprises one or more data structures wherein each data structure is populated with a plurality of corresponding rules. As data is added to the business processing system of FIG. 9, the dynamic rules module is modified in real time and a specific data structure or data structures applicable to a particular project, process or the like and the needed corresponding rules are copied to a subset module, a project or process module. Based on the dynamic rules protocols, various users will thus obtain differing subset modules in a secure manner. These users may individually manipulate the data structure provided for individual requirements using the certification equivalency module. The user may provide additional and/or modified data to the expert system that in real time modifies the dynamics rules module in an interoperable real time dynamic feedback loop system. Optionally, the data mining and expert knowledge module input effects real-time modification of a business intelligence processing module and/or a dynamic rules module. Users are restricted in their ability to modify the dynamic rules module based on the business intelligence processing module.

The embodiments described in FIG. 9 may provide each user with two data output sets. One is a data set tailored to the specific end user according to the dynamic rules module and the second is a shared data set among independent third-party users according to the dynamic rules module. Thus certification equivalency as an exemplary embodiment can be generated according to the specific requirements of a single user. Optionally a set of unconnected entities can agree upon a common set of rules according to the dynamic rules module thus enabling the generation of certification equivalency module according to these common rules. The dynamic rules module can be modified in real time through the secure interoperability of the expert system of this embodiment.

What is claimed is:

1. A real-time interoperable system comprising a business intelligence processing module;
a dynamic rules module coupled to said business intelligence module;
a dynamic collaboration engine coupled to said dynamic rules module and said business intelligence processing module;
wherein system data output and reporting is provided via a secure online method providing real-time interoperability among disconnected facilities.

2. The system of claim 1 wherein the system provides third party business partners secure, dynamic and real-time decision making capabilities based on third party's available data set and
wherein data output and reporting is provided via a secure online method providing real-time interoperability among disconnected facilities.

3. A real-time interoperable system comprising
a business intelligence processing module;
a dynamic rules module coupled to said business intelligence module;
a dynamic collaboration engine coupled to said dynamic rules module and said business intelligence processing module;
a data mining and expert knowledge module coupled to said interoperable system wherein said expert knowledge module can affect a portion of a data set to undergo real-time modification;
wherein system data output and reporting is provided via a secure online method providing real-time interoperability among disconnected facilities.

4. The real-time interoperable system according to claim 3, wherein said dynamic rules module is applied to credentials management

5. The system of claim 3 wherein new knowledge is acquired via real-time acquisition of data, said new knowledge is added to the business intelligence processing module and the dynamic rules module coupled to said business intelligence module is modified.

6. The system of claim 3 applied to real-time worker verification

7. The system of claim 3 applied to payment processing

8. The system of claim 3 applied to data mining activities and processing

9. The system of claim 3 with improved intersystem connectivity comprising improved real-time intercompany or inter-unit transfer of data

10. The system of claim 1 implemented with secure wireless hand-held devices

11. The real-time interoperable system according to claim 3, wherein said dynamic collaboration module is applied to certification management

12. The real-time interoperable system according to claim 3, wherein said dynamic collaboration module is applied to certification equivalencies.

13. The real-time interoperable system according to claim 3, is applied to creation of user and processing audit information.

14. A real-time interoperable system comprising
a business intelligence processing module;
a dynamic rules module coupled to said business intelligence module;
a dynamic collaboration-engine coupled to said dynamic rules module and said business intelligence processing module;
a data mining and expert knowledge module coupled to said interoperable system wherein said expert knowledge module can affect a portion of a data set to undergo real-time modification;
wherein third party's business processes are emulated

15. The system of claim 14 wherein the system provides third party business partners secure, dynamic and real-time decision making capabilities based on third party's available data set wherein data output and reporting is provided via a secure online method providing real-time interoperability among disconnected facilities

16. The system of claim 14 wherein a third party entity selects, compares and evaluates various defined business and module data elements to affect a reaction in a dynamic manner without any custom coding.

17. The system of claim 14 as applied to the preparation of card printing comprising
i. A dynamic formatting procedure including formatting a variety of card types
ii. Validation of data set prior to card printing
wherein the system provides third party business partners secure, dynamic and real-time decision making capabilities based on third party's available data set wherein data output and reporting is provided via a secure online method providing real-time interoperability among disconnected facilities.

18. The real-time interoperable system according to claim 14, wherein said dynamic rules module and said dynamic collaboration module as applied to notification generation and processing.
